(19) United States
(12) Patent Application Publication
(10) Pub. No.: US 2003/0005440 A1
(43) Pub. Date: Jan. 2, 2003

(54) Management of electronic program guides

(76) Inventors: Karin Axelsson, Linkoping (SE); Marcus Bernhardson, Linkoping (SE); Conny Forsander, Linkoping (SE); Fredrik Paulsson, Linkoping (SE)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/891,331

(22) Filed: Jun. 27, 2001

(51) Int. Cl. G06F 3/00; H04N 5/445; G06F 13/00; H04N 7/173; H04N 7/16; H04N 7/00; H04N 11/00

(52) U.S. Cl. 725/39; 725/50; 725/133; 348/552; 725/141

(57) ABSTRACT

A method of managing Electronic Program Guide data in a digital entertainment system comprising a multimedia terminal is described. The method comprises the steps of retrieving Electronic Program Guide data, transferring the Electronic Program Guide data to a mobile terminal; editing the Electronic Program Guide data in mobile terminal; and transferring the Electronic Program Guide data to the multimedia terminal. This provides for efficient managing of an Electronic Program Guide in a system comprising a multimedia terminal.

### FIELD OF INVENTION

The present invention generally relates to the management of programs for home entertainment devices, such as televisions and Set Top Boxes. More particularly it relates to a method, a multimedia terminal, a mobile terminal, and a computer program for transferring Electronic Program Guides between different terminals and the editing of Electronic Program Guide data.

### BACKGROUND

An Electronic Program Guide (EPG) is an application provided in a multimedia terminal or a home entertainment device, such as a Set Top Box (STB) designed to aid a viewer in the navigation of and selection from broadcast programs in a digital system. By means of the EPG, it is possible to make settings in the home entertainment device. It is also possible to register reminders and planned recordings as well as to filter the large amount of information available through the EPG. It is even possible to create a “virtual” channel comprising programs from different channels, as is described in the international publication WO 00/40028.

However, a problem associated with the use of EPGs is that the management thereof can be time-consuming considering the amount of information involved; an EPG covering one week normally contains several thousands of TV programs.

Another problem associated with the use of STBs and EPGs is that STBs are stationary whilst persons using EPGs are mobile. This means that a person having a STB must be in the same room or have access to the Internet in order to benefit from the EPG provided for that STB.

A further problem is that the opportunities to share the work put into an edited EPG are limited.

The patent documents U.S. Pat. Nos. 6,130,726 A, 5,710,605, and WO 00/59212 disclose distribution of EPG functionality between a STB and a remote control.

### SUMMARY OF THE INVENTION

An object of the present invention is to overcome the problems of prior art and to provide means for facilitating management of Electronic Program Guides in a home entertainment environment.

The invention is based on the realization, that EPG information can be transferred to and from an STB by means of a mobile terminal, such as a Personal Digital Assistant (PDA), a mobile phone, or an advanced remote control.

Thus, according to a first aspect of the invention there is provided a method of managing Electronic Program Guide data in a digital entertainment system comprising a multimedia terminal, said method comprising the following steps: retrieving Electronic Program Guide data; transferring said Electronic Program Guide data to a mobile terminal; editing said Electronic Program Guide data by means of said mobile terminal; and transferring said Electronic Program Guide data to said multimedia terminal.

According to a second aspect there is provided multimedia terminal comprising control electronics; a tuner connected to said control electronics; an electronic storage connected to said control electronics; an encoder connected to a display connector and to said control electronics; a communication device connected to said control electronics for communication with a mobile terminal; wherein said terminal is arranged to receive an Electronic Program Guide transmitted by said mobile terminal.

According to a third aspect there is provided a mobile terminal comprising: control electronics for controlling the operation of said mobile terminal; an input device connected to said control electronics; a display connected to said control electronics; an electronic storage for storing software and data connected to said control electronics; a communication device connected to said control electronics and being arranged to communicate with a multimedia terminal; wherein said electronic storage comprises software code portions for performing the following steps: receiving an Electronic Program Guide from a multimedia terminal by means of said communication device; editing said received Electronic Program Guide; and transmitting said edited Electronic Program Guide to a multimedia terminal.

According to a fourth aspect there is provided computer program product directly loadable into the internal memory of a mobile terminal, said computer program product comprising software code portions for performing the following steps: receiving Electronic Program Guide data; editing said Electronic Program Guide data by means of said mobile terminal; and transmitting said Electronic Program Guide data to a multimedia terminal.

With the method, the multimedia terminal, the mobile terminal, and the computer program product according to the invention, the above mentioned problems in a home entertainment environment are solved or at least mitigated. More specifically, the invention provides means for managing EPG Data in an efficient way. By means of the inventive concept, it is also possible to share EPGs between different STBs in a convenient way.

### BRIEF DESCRIPTION OF DRAWINGS

The invention is now described, by way of example, with reference to the accompanying drawings, in which:

FIG. 1 is a flow chart describing the method according to the invention;

FIG. 2 is a diagram showing the general information flow in a system according to the invention;

FIG. 3 and 4 show alternative embodiments of a system incorporating the invention; and

FIG. 5 is a detailed diagram showing a Set Top Box and a Mobile Terminal.

### DETAILED DESCRIPTION OF THE INVENTION

In the following, a detailed description of embodiments of the invention will be given. In the description, for purposes of explanation and not limitation, specific details are set forth, such as particular hardware, applications, techniques etc. in order to provide a thorough understanding of the present invention. However, it will be apparent to one skilled in the art that the present invention may be utilized in other embodiments that depart from these specific details. In other instances, detailed descriptions of well-known methods, apparatuses, and circuits are omitted so as not to obscure the description of the present invention with unnecessary details.

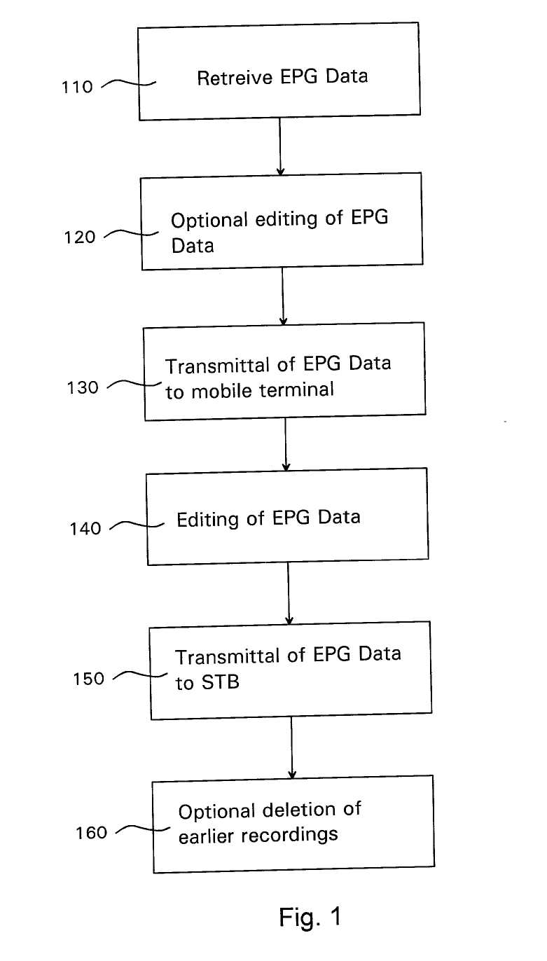

In FIG. 1, a flow chart describing the general inventive idea is shown. In a first step 110, data of an Electronic Program Guide (EPG) is retrieved by means of a Set Top Box (STB) or a Personal Computer (PC) connected to an information network, such as a cable, terrestrial, or satellite network, the Internet etc. This retrieval can be effected automatically, such as every night, or at the request of a user. The EPG data comprises information regarding TV programs during the next seven days, for example, such as TV channel, name, a unique identification, start and stop times, a classification (adult, children, sports etc.), and sometimes a short abstract.

Considering the large amount of data, this can optionally be filtered in a second step 120. This filtering can delete data regarding TV programs falling outside of the field of interest of the EPG user and is a known feature.

In a third step 130 the EPG Data is transferred from the stationary terminal to a Mobile Terminal (MT), such as a mobile phone or a PDA. This transfer can be performed in several ways, as will be described below. The MT is provided with software for managing an EPG. This software is used in a fourth step 140 for editing the EPG data downloaded to the MT. This editing can include setting reminders and recordings as well as further filtering of the data. Because this editing is performed in a mobile terminal, it can be done in a more convenient way and when the user has no access to a device conventionally used for editing EPG Data, such as an STB connected to a display unit, such as a TV set.

When the EPG data has been edited, it is subsequently transferred in a fifth step 150 to an STB used for displaying the TV programs on a TV set, for example. Sometimes, the transferred data contains information in conflict with information already stored in the STB to which the data is transferred. For example, data requesting recording of a program on a specific TV channel at a specific time is in conflict with a request for recording another program on another TV channel at the specific time. In that case, in a sixth step 160, the user is given the choice of either replacing the previously recorded request with the request in the now downloaded data or keeping the old request. In the latter case, the request for recording can be transformed into a reminder instead.

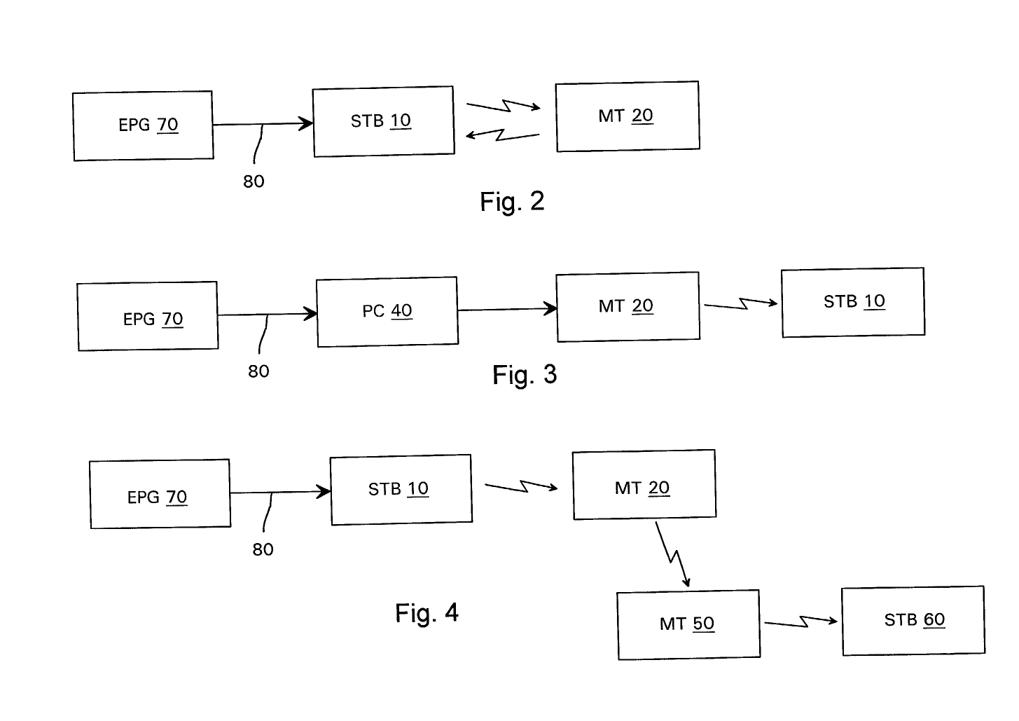

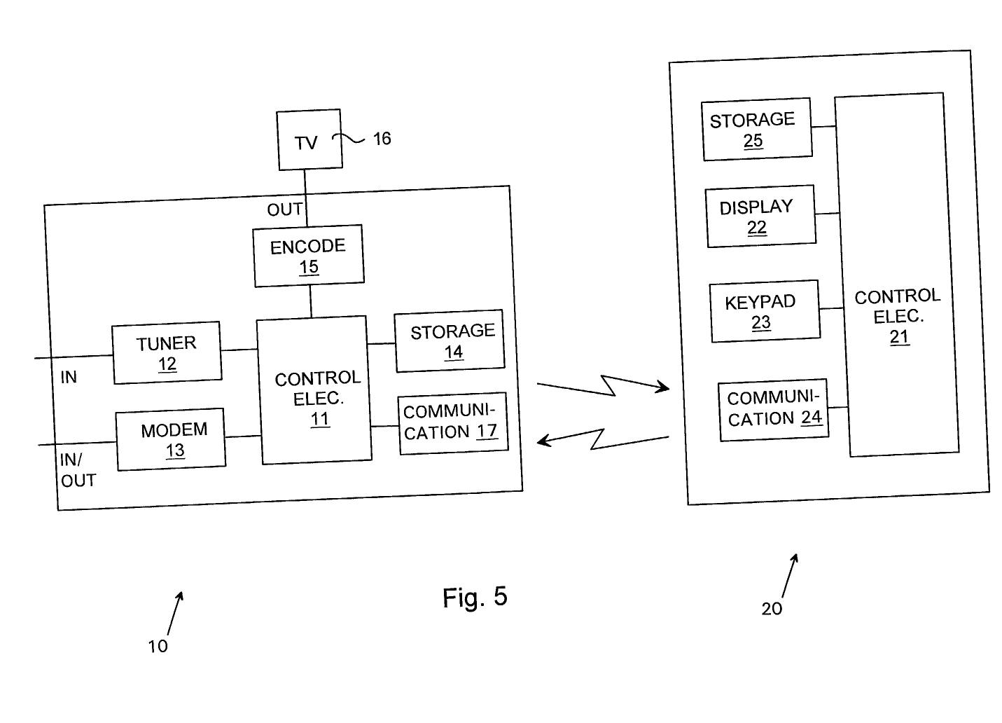

A first example of an implementation of the inventive method will now be given with reference to FIG. 2 and also to FIG. 5, wherein an STB 10 and an MT 20 are shown in detail. The STB 10 is provided in a home entertainment environment comprising a TV set 16 (shown in FIG. 5) for displaying TV programs. The STB is also connected to a source of EPG Data 70 through some kind of communication network 80, such as a cable, terrestrial, or satellite network, the Internet etc. It is thus possible to retrieve an EPG by means of the STB 10.

With reference to FIG. 5, the STB 10 comprises control electronics 11 controlling the function of the device. Various other parts are connected to the electronics 11, such as a tuner 12 arranged to receive digital audio and video information, a modem 13 connectable to a data network, such as the Internet, an electronic storage 14 for software and data, such as an EPG, an encoder for displaying information on an attached TV set 16, and a communication device 17, such as an IR communication device or an RF transceiver device.

The mobile terminal 20 also comprises control electronics 21, as is conventional. It further comprises a display 22, such as an LCD, for displaying information, and an input device in the form of a keypad 23 for entering information. A communication device 24 is arranged to communicate with the communication device 17 of the STB 10. Finally, an electronic storage 25 is provided for storing software and data.

When the EPG has been retrieved in the STB 10, the user can edit the information as is conventional. This editing comprises filtering and setting reminders and requesting recordings. However, at this stage editing is optional in the STB.

The EPG data is then transferred to the Mobile Terminal (MT) 20. In the figure this transfer is shown as being wireless. Thus, any conventional wireless transfer method can be used, such as by means of infrared (IR) communication, radio communication, such as in accordance with the Bluetooth(r) standard, etc. Wireless communication is easy to use and provides for a simple system without too much equipment and devices.

When the EPG data has been transferred to the MT, the user can edit the data stored in the MT. This editing can take place anywhere and anytime and is not limited to a location in connection with a multimedia system. For example, if the transfer takes place in the morning, the user can edit the data on his or her way to and from work, sitting on a bus or in a train, for example. This indeed adds another dimension of flexibility to the use of a home entertainment system.

After having edited the EPG Data in the MT 20, the user retransmits the now edited data to the STB 10. Continuing the example above, this can be done after having returned from work, for example. Thus, instead of having to use the EPG when about to watch TV, the user can just sit down and transfer the EPG to the STB 10 without the risk of missing a TV program.

It will be appreciated that the transfer of information to the STB 10 can involve some kind of authentication procedure. For example, the user must supply a PIN code before the STB 10 accepts any recordings or request.

The MT 20 can contain some kind of personalized filter. By means of this filter, the EPG data transferred to the MT is automatically adapted to the preferences of the user. This use of the inventive method provides for an easy way to adapt a home entertainment environment to a particular user and is a more flexible alternative to having different user profiles stored in the STB.

A second example of the use of the inventive method will now be given with reference to FIG. 3, wherein a Personal Computer (PC) 40 connected to an EPG source 70 via a data or other kind of communication network 80, an MT 20 and an STB 10 are shown. In this example, information transmission between the PC 40 and the MT 20 is effected by means of wire, such as by means of a MT docking station connected to the PC.

It is envisaged that the PC 40 can be provided at another location than the STB 10, such as at the user's office, wherein the PC is connected to the Internet 80. A user can then, during lunchtime, for example, download an EPG to the PC 40 from a site on the Internet using TCP/IP and ftp. The user then retransmits the EPG to the MT 20 connected to the PC 40. At his or her way back home after work, the user can edit the EPG Data. After having returned home, the user transmits the data to the STB 10, just as in the first example given above.

A third example of the use of the inventive method will now be given with reference to FIG. 4, wherein a first STB 10 connected to an EPG source 70 via a data network 80, and a second 60 STB are shown together with a first 20 and a second 50 MT. In this example, the information transfer between the different devices is wireless.

The transfer of EPG data from STB 10 to MT 20 is carried out as in the first example above given with reference to FIG. 2. The editing of data in the MT 20 has also been described above. However, instead of retransmitting the edited data to the STB 10 from which the EPG was retrieved, the data is sent to the second MT 50. As an example, the two MTs 20 and 50 are two mobile phones owned by two friends or working mates. When the owner of the first MT 20 has edited the data, he or she gives the data to the owner of the second MT 50. The information transfer can be carried out by means of an IR connection commonly found on mobile phones of today, for example. Another way is to use Short Message Service (SMS) or corresponding communication systems to transfer the information to a remote second MT 50.

The owner of the second MT 50 subsequently transfers the edited data to his or her STB 60, which can be situated far from the first MT 10. Thus, the inventive method provides for a way to exchange information between different home entertainment systems.

Preferred embodiments of the invention have been described. It is realized that these can be varied within the scope of the appended claims. For example, encryption of data can be used to increase the level of security, if so desired.

Also, the transfer of EPG information regarding TV programs has been described. It will be appreciated that other kind of information used in a home entertainment environment could be transferred as well. An example of that are Internet Protocol (IP) addresses to file servers. Thereby, information regarding for example music files, such as MP3 files, can be exchanged between friends and be incorporated in a playlist of programs.

In this description references have been made to TV sets. It will be appreciated that these references also cover other kinds of display units, such as computer monitors etc.

Also, specific communication methods have been described. Other methods and combination of methods are also possible. For example, in the example described with reference to FIG. 3, the communication between PC 40 and MT 20 can be by means of wireless communication etc.

1. A method of managing Electronic Program Guide data in a digital entertainment system comprising a multimedia terminal, said method comprising the following steps:
retrieving Electronic Program Guide data;
transferring said Electronic Program Guide data to a mobile terminal;
editing said Electronic Program Guide data by means of said mobile terminal; and
transferring said Electronic Program Guide data to said multimedia terminal.

2. The method according to claim 1, wherein the step of transferring said Electronic Program Guide data to a mobile terminal is preceded by the additional step of editing said Electronic Program Guide data.

3. The method according to claim 1, wherein the step of editing said Electronic Program Guide data comprises setting a reminder, requesting a recording, and/or filtering said Electronic Program Guide data.

4. The method according to claim 1, wherein the step of transferring said Electronic Program Guide data to said multimedia terminal is preceded by the additional step of transferring said Electronic Program Guide data from said mobile terminal to a second mobile terminal.

5. The method according to claim 4, wherein the additional step of transferring said Electronic Program Guide data from said mobile terminal to a second mobile terminal comprises using IR communication or a Short Message Service.

6. The method according to claim 1, wherein said mobile terminal comprises any of the following: a mobile phone, a Personal Digital Assistant, and a remote control.

7. The method according to claim 1, wherein the step of retrieving Electronic Program Guide data comprises using a cable, terrestrial, or satellite network, or a data network.

8. The method according to claim 7, wherein said data network comprises the Internet.

9. The method according to claim 1, wherein the step of transferring said Electronic Program Guide data to a mobile terminal comprises using any of the following: infrared communication, radio communication, and wired communication.

10. The method according to claim 9, wherein said radio communication operates in accordance with the Bluetooth(r) standard.

11. The method according to claim 9, wherein using wired communication comprises using a docking station.

12. The method according to claim 1, wherein the step of transferring said Electronic Program Guide data to said multimedia terminal involves an authentication procedure.

13. The method according to claim 12 wherein said authentication procedure comprises supplying a PIN code to said multimedia terminal.

14. The method according to claim 1, wherein the step of editing said Electronic Program Guide data by means of said mobile terminal comprises filtering said Electronic Program Guide data by means of a personalized filter.

15. The method according to claim 1, wherein said Electronic Program Guide data comprises any of the following items: TV channel, name, unique identification, start and stop times, classification, abstract, and Internet Protocol address.

16. A multimedia terminal comprising:
control electronics;
a tuner connected to said control electronics;
an electronic storage connected to said control electronics;
an encoder connected to a display connector and to said control electronics;
a communication device connected to said control electronics for communication with a mobile terminal;
wherein said terminal is arranged to receive Electronic Program Guide data transmitted by said mobile terminal.

17. The multimedia terminal according to claim 16, comprising a device for connecting to a cable, terrestrial, or satellite network, or to a data network.

18. The multimedia terminal according to claim 16, comprising an infrared communication device, a radio communication device, or a wired communication device.

19. The multimedia terminal according to claim 18, wherein said radio communication device operates in accordance with the Bluetooth(r) standard.

20. The multimedia terminal according to claim 18, wherein said wired communication device comprises a docking station.

21. The multimedia terminal according to claim 16, wherein said Electronic Program Guide data comprises any of the following items: TV channel, name, unique identification, start and stop times, classification, abstract, and Internet Protocol address.

22. A mobile terminal comprising:
control electronics for controlling the operation of said mobile terminal;
an input device connected to said control electronics;
a display connected to said control electronics;
an electronic storage for storing software and data connected to said control electronics;
a communication device connected to said control electronics and being arranged to communicate with a multimedia terminal;
wherein said electronic storage comprises software code portions for performing the following steps:
receiving Electronic Program Guide data from a multimedia terminal by means of said communication device;
editing said received Electronic Program Guide data; and
transmitting said edited Electronic Program Guide data to a multimedia terminal.

23. The mobile terminal according to claim 22, wherein said mobile terminal comprises any of the following: a mobile phone, a Personal Digital Assistant, and a remote control.

24. The mobile terminal according to claim 22, comprising any of the following: an infrared communication device, a radio communication device, and a wired communication device.

25. The mobile terminal according to claim 24, wherein said radio communication device operates in accordance with the Bluetooth(r) standard.

26. The terminal according to claim 24, wherein said wired communication device comprises a docking station.

27. The mobile terminal according to claim 22, wherein said electronic storage comprises a personalized filter for filtering said Electronic Program Guide data.

28. A computer program product directly loadable into the internal memory of a mobile terminal, said computer program product comprising software code portions for performing the following steps:
receiving Electronic Program Guide data;
editing said Electronic Program Guide data by means of said mobile terminal; and
transmitting said Electronic Program Guide data to a multimedia terminal.

29. The computer program product according to claim 28, wherein the step of editing said Electronic Program Guide data by means of said mobile terminal comprises filtering said Electronic Program Guide data by means of a personalized filter.

30. The computer program product according to claim 28, comprising additional software code portions for performing the step of transmitting said Electronic Program Guide data to a second mobile terminal.

31. The computer program product according to claim 28, wherein said mobile terminal comprises any of the following: a mobile phone, a Personal Digital Assistant, and a remote control.
